(19) United States
(12) Patent Application Publication
(10) Pub. No.: US 2002/0001498 A1
(43) Pub. Date: Jan. 3, 2002

(54) Collapsible keyboard

(75) Inventors: Chin-Cheng Li, Hsin-Chuang City (TW); Yuh-Fank Lin, Pan-Chiao City (TW)

Correspondence Address: Richard P. Berg, Esq., c/o LADAS & PARRY, Suite 2100, 5670 Wilshire Boulevard, Los Angeles, CA, 90036-5679, US

(73) Assignee: Acer Communications and Multimedia, Inc.

(21) Appl. No.: 09/897,658

(22) Filed: Jun. 29, 2001

(30) Foreign Application Priority Data
Jul. 1, 2000 (TW) 89211341

(51) Int. Cl. B41J 5/14

(52) U.S. Cl. 400/472

(57) ABSTRACT

A collapsible keyboard that includes a base, at least one hinge and a plurality of keys. The base has a plurality of sections. The keys are provided on the sections of the base. The hinge connects the plurality of sections so that the sections are rotatable with respect to each other, allowing collapsibility of the keyboard to facilitate transport.

### BACKGROUND OF THE INVENTION

1. Field of the Invention

The present invention relates in general to a collapsible keyboard that can be folded into a reduced size, facilitating transport.

2. Description of the Related Art

Generally, characters and symbols are input into a computer via a keyboard. Other input equipment such as mouse pointers or light pens fail to offer input speed and ease to match the keyboard. Therefore, the popularity of keyboards remains universal.

A conventional keyboard has a base and a plurality of keys mounted thereon. The user inputs data into the computer by typing the keys of the keyboard. Operation of the computer using the keyboard is easy and fast. Conventional keyboards are, however, too long to allow easy transport.

### SUMMARY OF THE INVENTION

An object of the present invention is to provide a collapsible keyboard that can be folded into a reduced size, facilitating transport.

The keyboard of the present invention includes a base, at least one hinge and a plurality of keys. The base has a plurality of sections. The keys are provided on the sections of the base. The hinge connects the plurality of sections so that the sections are rotatable with respect to each other.

The keyboard in use has a longitudinal size equal to that of a conventional keyboard to comply with user habits. When the keyboard is not in use, the user can fold the keyboard into its reduced size and easily carry it.

### BRIEF DESCRIPTION OF THE DRAWINGS

The present invention can be more fully understood by reading the subsequent detailed description and examples with references made to the accompanying drawings, wherein:

FIG. 1 is a top view of a collapsible keyboard in accordance with the first embodiment of the present invention;

FIG. 2 is a front view of the collapsible keyboard in accordance with the first embodiment of the present invention;

FIG. 3 is a front view of the keyboard of the first embodiment of the present invention, in a folded state;

FIG. 4 depicts the keyboard of the first embodiment of the present invention, disposed in a case;

FIG. 5 is a top view of a collapsible keyboard in accordance with a second embodiment of the present invention;

FIG. 6 is a front view of the collapsible keyboard in accordance with the second embodiment of the present invention;

FIGS. 7 and 8 depict the process of folding the keyboard of the second embodiment of the present invention; and

FIG. 9 depicts the keyboard of the second embodiment of the present invention, disposed in a case;

### DETAILED DESCRIPTION OF THE PREFERRED EMBODIMENT

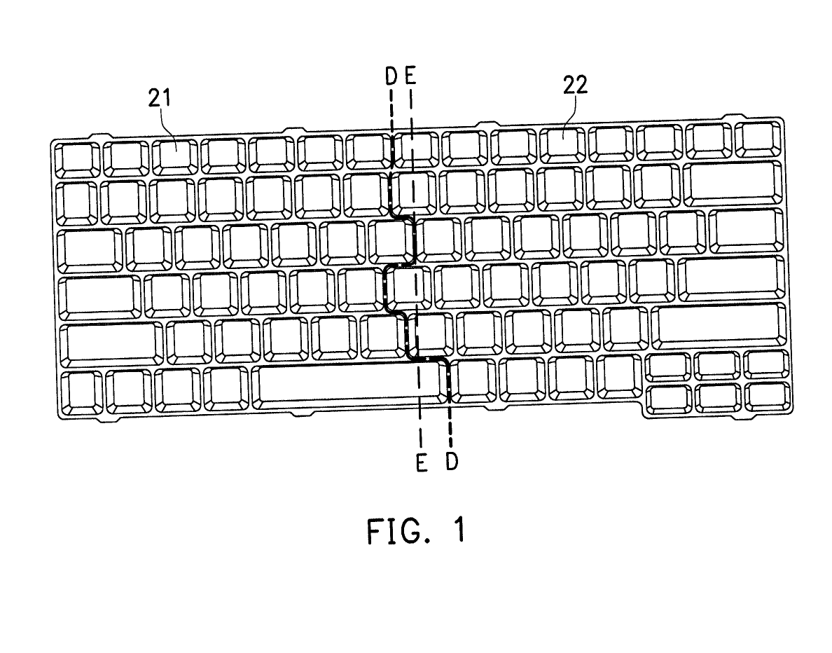

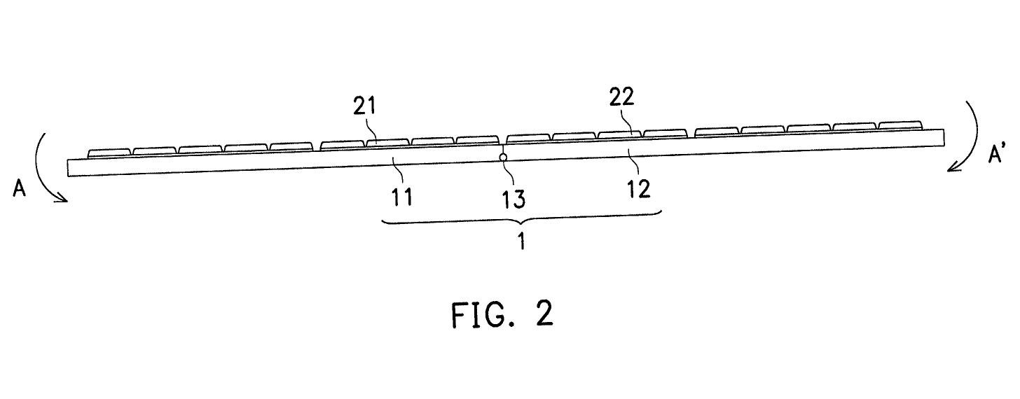

Referring to FIGS. 1 and 2, a collapsible keyboard of a first embodiment of the present invention includes a base 1 and a plurality of keys 21, 22. The base 1 has a first section 11 and a second section 12 connected by a hinge 13 so that the first and second sections 11, 12 are rotatable with respect to each other. The keys 21, 22 are provided on the first and second sections 11, 12. The user types the keys 21, 22 to output corresponding signals to a computer (not shown).

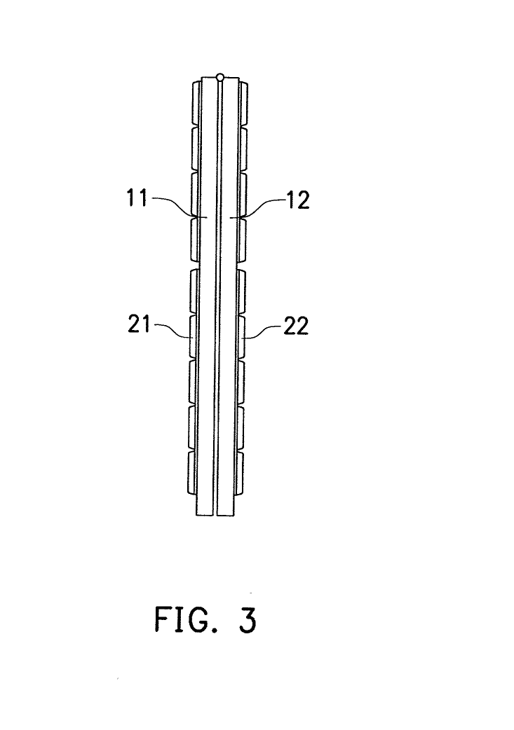

FIG. 2 shows the keyboard in use, wherein the keyboard is open and has a longitudinal size equal to that of a conventional keyboard to comply with user habits. To fold the keyboard, the user rotates the first and second sections 11, 12 in directions A, A′. In FIG. 1, broken line D-D indicates the location where the keys 21, 22 separate. Broken line E-E indicates the location where the base is folded, which is also the location of the hinge 13. The first section 11 and the second section 12 are rotated toward each other via the hinge 13 until the bottoms of the sections 11, 12 contact each other. The keys 21, 22 of the keyboard face out. As shown in FIG. 3, the longitudinal size of the keyboard is reduced by 50%. It is convenient for the user to carry the folded keyboard.

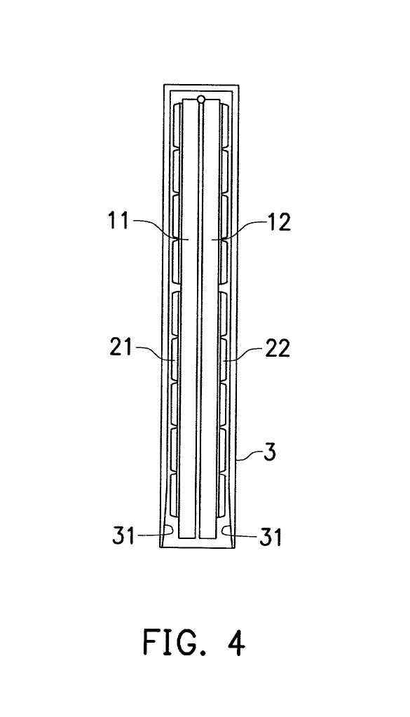

Referring to FIG. 4, the folded keyboard can be disposed in a case 3. The case 3 protects the keyboard from impact and dust. Furthermore, the case 3 has an opening and an inclined inner surface 31 at the opening, facilitating an insertion of the keyboard into the case 3.

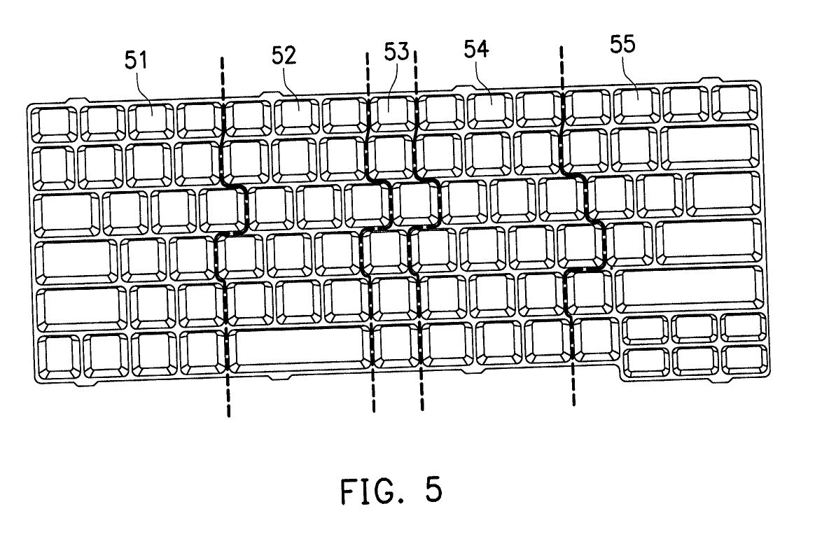

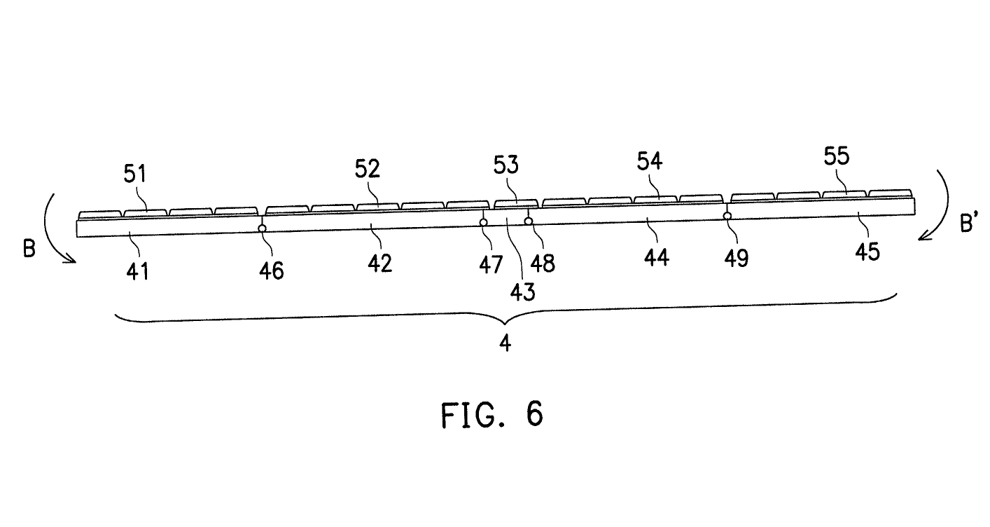

Referring to FIGS. 5 and 6, a collapsible keyboard of a second embodiment of the present invention includes a base 4 and a plurality of keys 51, 52, 53, 54, 55. The base 4 has a first section 41, a second section 42, a third section 43, a fourth section 44 and a fifth section 45 connected by hinges 46, 47, 48, 49 so that the sections 41, 42, 43, 44, 45 are rotatable with respect to each other. The keys 51, 52, 53, 54, 55 are provided on the first, second, third, fourth and fifth sections 41, 42, 43, 44, 45, respectively. The user types the keys 51, 52, 53, 54, 55 to output corresponding signals to a computer (not shown).

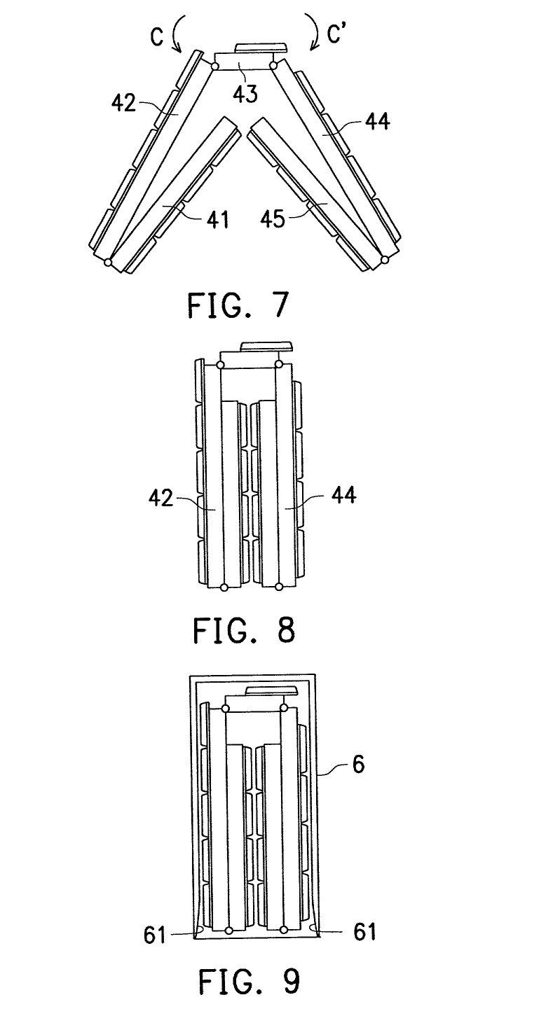

FIG. 6 shows the keyboard in use, wherein the keyboard is open and has a longitudinal size equal to that of a conventional keyboard to comply with user habits. To fold the keyboard, the user rotates the first and fifth sections 41, 45 in directions B, B′. In FIG. 5, broken lines indicate the locations where the keys 51, 52, 53, 54, 55 separate. The first section 41 and the fifth section 45 are rotated toward each other via the hinges 46, 49 until the sections 41, 45 contact the bottoms of the sections 42, 44. Referring to FIG. 7, the second and fourth sections 42, 44 are then rotated toward each other in directions C, C′. FIG. 8 shows the result, the longitudinal size of the keyboard is reduced by 75%. It is convenient for the user to carry the folded keyboard.

Referring to FIG. 9, the folded keyboard can be disposed in a case 6. The case 6 protects the keyboard from impact and dust. Furthermore, the case 6 has an opening and an inclined inner surface 61 at the opening, facilitating an insertion of the keyboard into the case 6.

The keyboard of the first embodiment of the present invention has two sections. When the keyboard is folded, the longitudinal size of the keyboard is reduced by 50%. The keyboard of the second embodiment has five sections. When the keyboard is folded, the longitudinal size of the keyboard is reduced by 75%. However, the keyboard of the second embodiment has more hinges than that of the first embodiment.

In conclusion, the present invention provides a collapsible keyboard. The keyboard in use has a longitudinal size equal to that of a conventional keyboard to comply with user habits. When the keyboard is not in use, the user can fold the keyboard so that the keyboard has a reduced size and easily carried.

While the invention has been described by way of example and in terms of the preferred embodiment, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A collapsible keyboard including:
a base having a plurality of sections, the plurality of sections have first surfaces and second surfaces opposite the first surfaces;
at least one hinge connecting the plurality of sections so that the plurality of sections are rotatable with respect to each other;
a plurality of keys provided on the first surfaces of the plurality of sections, wherein the second surfaces of the plurality of sections contact each other when the keyboard is folded.

2. A collapsible keyboard as claimed in claim 1, wherein the base has two sections.

3. A collapsible keyboard as claimed in claim 1, wherein the base has five sections.

4. A collapsible keyboard including:
a base having a plurality of sections;
at least one hinge connecting the plurality of sections so that the plurality of sections are rotatable with respect to each other;
a plurality of keys provided on the plurality of sections, wherein the plurality of sections are sandwiched between the plurality of keys when the keyboard is folded.

5. A device comprising:
a keyboard including a base, at least one hinge and a plurality of keys, wherein the base has at least two sections, the at least two sections have first surfaces and second surfaces opposite the first surfaces, the hinge connects the at least two sections so that the at least two sections are rotatable with respect to each other, the plurality of keys are provided on the first surfaces of the at least two sections, and the second surfaces of the at least two sections contact each other when the keyboard is folded; and
a case used for receiving the keyboard.

6. A device as claimed in claim 5, wherein the case has at least one inclined inner surface, facilitating an insertion of the keyboard into the case.

7. A device as claimed in claim 6, wherein an opening is provided on the case, and the at least one inclined inner surface is formed at the opening.
